(19) United States
(12) Patent Application Publication
(10) Pub. No.: US 2010/0127094 A1
(43) Pub. Date: May 27, 2010

(54) Simple automatic sprinkler assistant

(76) Inventor: Vuong Binh Hong, Costa Mesa, CA (US)

Correspondence Address: Vuong Binh Hong, 3132 Coolidge ave, Costa Mesa, CA, 92626, US

(21) Appl. No.: 12/313,497

(22) Filed: Nov. 21, 2008

(51) Int. Cl. A01G 27/00

(52) U.S. Cl. 239/70

(57) ABSTRACT

The simple automatic sprinkler assistant is an apparatus to help the regular sprinkler timer to become a simple, fully automatic and zero maintenance sprinkler control system. The simple automatic sprinkler assistant combines with the regular sprinkler timer will automatically stop the sprinklers from watering when the air Relative Humidity (RH) is above certain target RH such as 70% RH. The simple automatic sprinkler assistant is connected in series and between the regular sprinkler timer and the valves. If it rains, when the Relative Humidity is above the target RH such as 70% RH, the simple automatic sprinkler assistant stops the sprinkler valves from watering the lawn.

The simple automatic sprinkler assistant is an apparatus to help the regular sprinkler timer to become a simple, fully automatic and zero maintenance sprinkler control system. The simple automatic sprinkler assistant combines with the regular sprinkler timer will automatically irrigate the lawn only when the Relative Humidity (RH) is below or equal certain target RH such as 70%. The simple automatic sprinkler assistant can be used to replace the rain sensor to stop the sprinkler when it rains because the RH of the air is very high when it rains. The simple automatic sprinkler assistant is connected in series and between the regular sprinkler timer and the valves.

### BACKGROUND OF THE INVENTION

There is a critical need to conserve water due to limited resources of water and an increasing population; however, it is important to ensure that the plants receive the minimum amount of water required for them to remain healthy.

How much water is needed for each kind of plant varies, and how much water is needed to irrigate the land varies greatly with different kinds of soils, climates, temperatures, air pressures, and most importantly, the amount of moisture. Temperature and moisture determine the rate of evaporation of water from the land and plants. The hotter or drier an area is, the more water needed to irrigate the plants. To determine how much water is optimum to irrigate the plants at certain times, Relative Humidity (RH) value is an important factor. The regular sprinkler timer is rigid so it is very difficult to avoid over watering or under watering. The smart sprinkler controller is much better but expensive, complicated to use and requires extensive maintenance. The present invention solves those issues by providing a sprinkler control system very simple to operate and best of all automatic and maintenance free. If the air RH is above a certain target RH, the present invention will assist the regular sprinkler timer by stopping the sprinkler valves from watering the lawn. The target RH can be made adjustable by using a variable resistor as described in the description portion. On the other hand, the regular sprinkler timer will work as normal.

For different kinds of lands or plants which require varying amounts of moisture, one just simply adjusts the watering time of the regular sprinkler timer. The rest will be taken care of by the present invention.

### REFERENCE

| | | |
|---|---|---|
| 7,063,271 | June 2006 | Lashgari |
| 5,853,122 | February 1998 | Caprio |
| 5,847,568 | Dec. 8, 1998 | Stashkiw, et al. |

U.S. Pat. No. 7,063,271, June 2006, Lashgari, “Moisture responsive sprinkler circuit” uses Ground humidity in the sprinkler control system. This approach has the advantage of measuring the moisture at the ground next to the roots of the plants; however, this approach has the drawbacks of the inhomogeneous of the land. The humidity at one point of the ground can be very different to the next. This disadvantage is more profound if the ground is not level. The present invention use air relative humidity to solve that problem. There is a close relationship between the air relative humidity and the ground humidity. If we carefully utilize the Relative Humidity reading, we can indirectly control the moisture of the ground. Further more, the air Relative Humidity is a very important factor for the plants. The air temperature and moisture affects the rate of evaporation of water from the land and plants. Thus the air Relative Humidity can help us to determine how much water is needed to irrigate the land with optimum results. The smart sprinkler system controller has high accuracy but expensive and requires extensive maintenance. The present invention solves that problem by introducing a very simple, low cost, simple to operate, automatic and best of all maintenance free.

U.S. Pat. No. 5,853,122, Caprio, Dec. 29, 1998, “Relative humidity sensitive irrigation valve control” intends to use relative humidity to control the sprinklers. The disadvantage of this invention is that it uses a humidistat and a thermostat to configure the RH of the air. This is very inconvenient and requires a lot of space. This invention uses a very small sensor to measure the RH of the air and the control circuit is very small also.

U.S. Pat. No. 5,847,568, Stashkiw, et al. Dec. 8, 1998, “Moisture sensor and irrigation control system”. This invention tries to measure the land moisture by the photo sensor. This approach is not very accurate. This invention uses a Relative Humidity sensor chip which gives a relative more accurate and easier method to control the sprinkler system.

### BRIEF DESCRIPTION OF THE SEVERAL VIEWS OF THE DRAWING

The above and other aspects, features and advantages of the present invention will be more apparent from the following more particular description thereof, presented in conjunction with the following drawings wherein:

FIG. 1 is a sprinkler system including a power supply circuit and a control circuit according to the present invention.

FIG. 2 shows the power supply circuit for the automatic sprinkler controller according to the present invention.

FIG. 3 shows the block diagram of the control circuit according to the present invention.

### DETAILED DESCRIPTION OF THE INVENTION

The following description is of the best mode presently contemplated for carrying out the invention. This description is not to be taken in a limiting sense, but is made merely for the purpose of describing one or more preferred embodiments of the invention. The scope of the invention should be determined with reference to the claims.

The present invention provides a simple but effective apparatus and method to enhance the regular sprinkler timer to become a low cost, automatic, maintenance free sprinkler system controller.

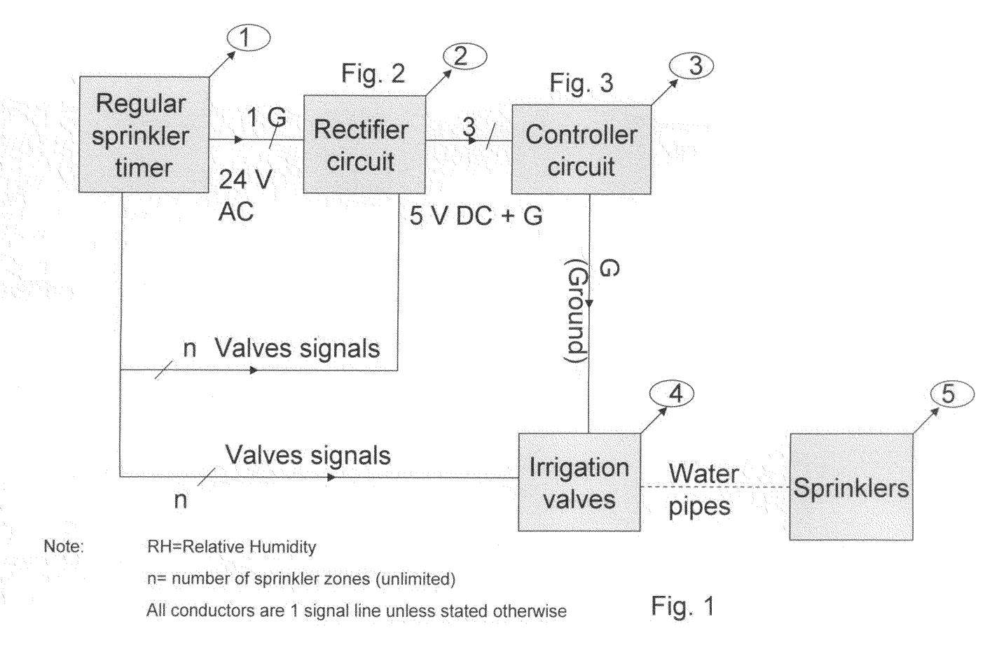

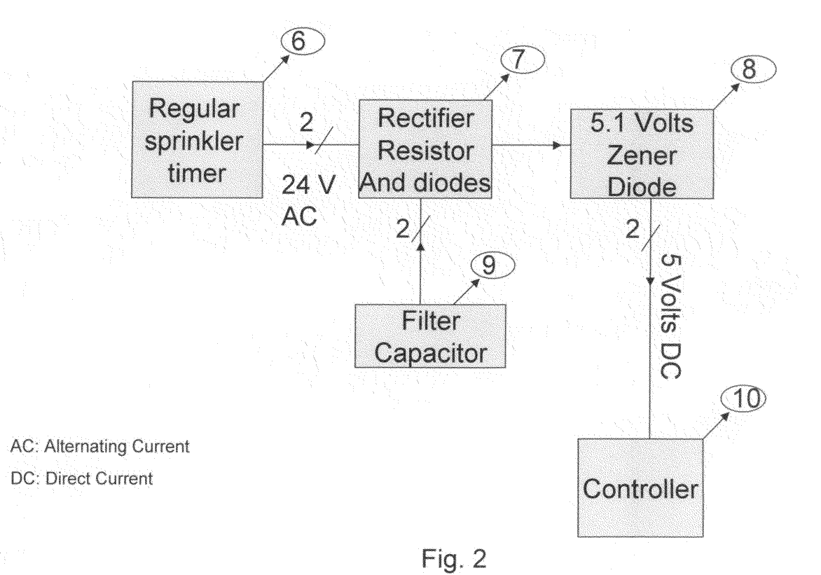

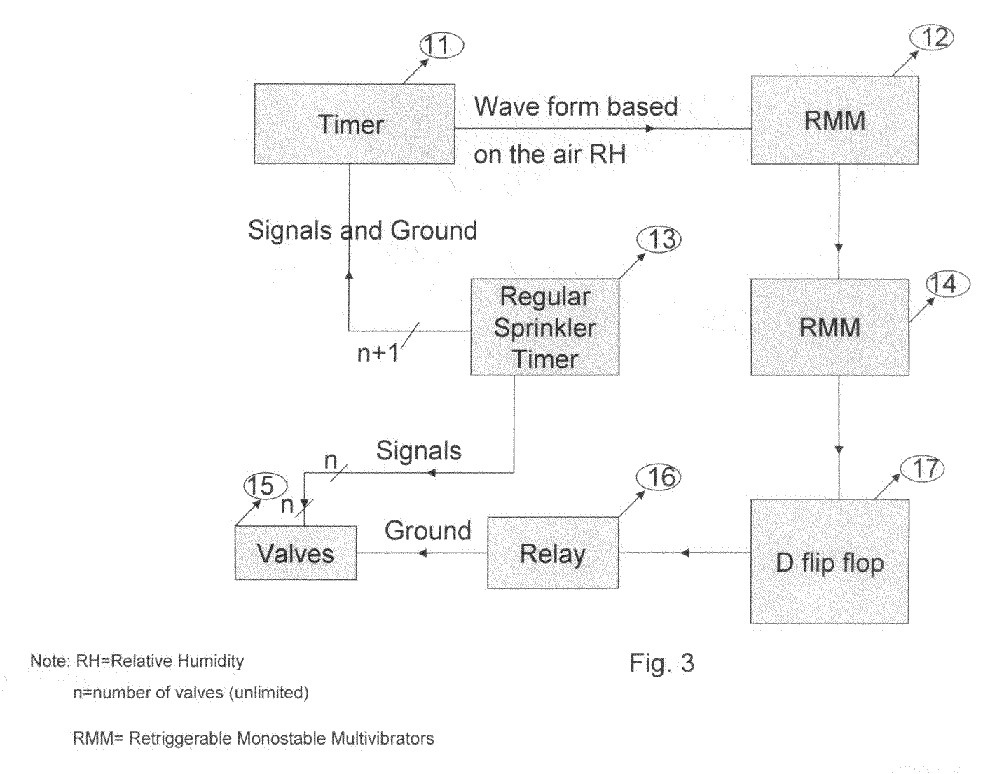

From FIG. 1, a regular sprinkler timer 1 has a 24 Volt Alternate Current (AC) signals and common lines which can be used to energize the present invention by connecting to the rectifier 2 through the conductors 1-2. The rectifier 2 shown in FIG. 2 converts the 24 Volt AC into 5 Volt Direct Current (DC) provides the power for all components of the present invention. The Controller Circuit 3 shown in FIG. 3 turns on or off the Irrigation Valves 4 by connecting or disconnecting the Ground signal to the Irrigation Valves 4. Only one zone or valve will be turn on at a time and unlimited number of valves can be turn on sequentially. The Regular Sprinkler Timer 1 provides the Irrigation Valves 4 the Valve Signals through the conductor 1-4 and the Controller Circuit 3 provides the Irrigation Valves 4 the common signal through the conductor 3-4.

FIG. 2 shows the rectifier circuit to convert 24 Volt AC to 5 Volt DC. The Rectifier diode 7 with the help of the Filter Capacitor 9 and 5.1 Volts Zener diode (or Voltage regulator) converts the 24 Volt AC into 5 Volts DC to supply power for the present invention.

FIG. 3 shows the brain of the present invention. Based on the capacitance of the Relative Humidity sensor chip, the RH Waveform generator 11 generates a wave form which frequency and period are dependent on the capacitance of the RH sensor which varies with the present air RH. The said waveform is connected to the input of the Retriggerable Monostable Multivibrators (RMM) 12 which is biased with external resistor and capacitor to generate a pulse which pulse width is equal to the period of the timer 11 wave form when the air RH is at the target RH (a variable resistor can be used in the place of the resistor to vary the target RH.) The results are that if the air RH is below or equal the target RH of the RMM 12, the output of the RMM 12 is a constant high straight line. On the other hand, if the air RH is higher than the target RH of the RMM 12, the output of the RMM 12 is pulses. The output of the RMM 12 is then connected to the input of the RMM 14. The pulse width of the RMM 14 is configured to be longer than the possible longest time period of the wave form of the timer 11. The output of the RMM 14 is a constant high if the input is pulses and constant low if the input is a constant (high or low.) The output of the second RMM 14 is the connected to the clock pin of the D flip flop 17 which is configured to output high at Q pin when clocked. The opposite /Q pin of the D flip flop 17 is then connected to an NPN transistor which will drive a relay. The relay will be turned on when the /Q pin of the D flip flop 17 is high and off when the /Q pin of the flip flop 17 is low. The Relay 16 turns on the Valves by allowing the common signal to go through or turns off the valves by blocking the common signal.

In summary, if the air RH is lower than the target RH set in the RMM 12, the output of the RMM 12 is a constant line, the output of the RMM 14 is low, the D flip flop does not change state in which Q pin is low and /Q is high. The relay 16 will allow the common signal going through and the valves turned on. On the contrary, all the states in the above paragraph are reversed and the valves are turned off.

What is claim is:

1) A sprinkler circuit: a relative humidity responsive circuit assists the regular sprinkler control timer by stopping the sprinkler valves from watering when the Relative Humidity (RH) is above certain target RH such as 70% RH.

2) The sprinkler circuit of claim 1, wherein the rectifier circuit generates 5 Volts source from the 24 Volt AC source supplied to the regular control timer.

3) The sprinkler circuit of claim 2, wherein one 0.7 Volts rectifier diode, one 2 Watts, 180 Ohms resistor, one 470 micro Farad, 16 Volts capacitor, and one 5.1 Volts Zener diode or a 5 Volts voltage regulators to convert the 24 Volt AC into 5 Volt DC source

4) The sprinkler circuit of claim 1, wherein the circuitry comprises of a relative humidity sensor chip, one timer such as 555 or equivalent timer, one retriggerable monostable multivibrators, one D flip flop, one NPN transistor, one solid state relay or equivalent and several resistors and capacitors.

5) The sprinkler circuit of claim 1, wherein the first timer generates wave form with frequency varies accordingly to the capacitance of the relative humidity sensor chip which reflects the temperature and moisture of the surrounding environment.

6) The sprinkler circuit of claim 1, wherein the wave form connects to the input of the retriggerable monostable multivibrators which is biased with one capacitor and one resistor to generate a wave form which width is equal to the pulse width of the 555 timer in the condition that the RH sensor at the target RH such as target RH.

7) The sprinkler circuit of claim 1, wherein the output of the one retriggerable monostable multivibrators is either constant or pulses. If the air RH is equal or below the target RH, the output is constant. On the other hand, if the air RH is above the target RH, the output is pulses.

8) The sprinkler circuit of claim 1, wherein the output of the one retriggerable monostable multivibrators connects to the input of another one retriggerable monostable multivibrators. The Q output of the second one retriggerable monostable multivibrators is ether high or low. It is high when the input is pulses and low when the input is constant.

9) The sprinkler circuit of claim 1, wherein the output of the second one retriggerable monostable multivibrators connects to the clock input of the D flip flop. The data input of the D flip flop is connected to 5 Volts. When the output of the second one retriggerable monostable multivibrators changes from low to high, the /Q output of the D flip flop changes states from high to low.

10) The sprinkler circuit of claim 1, wherein the /Q output of the D flip flop through a resistor connects to the base of a NPN transistor which collector connects to the solid state relay and the emitter connects to ground. The solid state relay turns on when the /Q output of the D flip flop is high and the solid state relay turns off when the /Q output of the D flip flop is low.

11) The sprinkler circuit of claim 1, wherein the solid state relay connects or disconnects the common conductor from the regular sprinkler timer to the common port of the valves. When the air RH is equal or below the target RH, the solid state relay connects the common port of the timer to the valves. And when the air RH is above the target RH, the solid state relay disconnects the common conductor from the timer to the valves and thus stops the sprinklers from watering the lawn or grass.
